(19) United States
(12) Patent Application Publication
(10) Pub. No.: US 2015/0285294 A1
(43) Pub. Date: Oct. 8, 2015

(54) Water Leak Preventing Washer

(71) Applicant: Donald M. Mullally, Yorba Linda, CA (US)

(72) Inventor: Donald M. Mullally, Yorba Linda, CA (US)

(21) Appl. No.: 14/247,925

(22) Filed: Apr. 8, 2014

(51) Int. Cl. F16B 43/00

(52) U.S. Cl. CPC F16B 43/001

(57) ABSTRACT

A washer of the present invention creates a tight seal and prevents water leaks when disposed between a female fitting and a male garden hose bib. It is substantially toroid in shape with wall that is tapered at an acute angle from its base perimeter. Otherwise, the washer wall can be curved such that its outer side is convex and its inner side is concave. An annular groove runs through the inner side of the wall serving to form a tighter seal. The washer is made of polyurethane or substantially equivalent material utilizing injection molding or other techniques known in the art.

### BACKGROUND OF THE INVENTION

### Field of the Invention

The present invention is in the field of leak preventing washers used in water hose systems.

### SUMMARY OF THE INVENTION

Most are familiar with the use of a garden hose and the issues that arise either from the start or over time with the connection of one hose with another or a spaying device attached to said hose and problems with water leakage therein. Unless a conventional coin shaped washer is inserted and replaced over the passage of time the uncomfortable issue of water leakage at the connection points is an ongoing issue.

As a result there is the need for a new connection device that can withstand the passage of time as well as be able to conform to the inner hose connection sections and create a tight seal where water is unable to escape.

Such a device needs to have unique shape and characteristics to represent a water hose connection system that will solve these problems.

Prior art consists of a variety of torus- or toroid-shaped washers used in garden or other hose systems where a number of segments are fitted together to provide a continuous, leak-proof water conduit. These washers, however, fail to establish a connection tight enough to prevent certain amounts of water from escaping at the couplings leading over time to substantial waste of water resources and, at times, to destruction of property caused by water damage.

The washer of the present invention provides a tight seal between a female fitting and a male hose bib. It is in the shape wherein it has the side walls of a right cone based frustum with the base circumference larger than the central opening. The walls can be straight or slightly convex, tapering at an acute angle from the base to opening. When disposed in a hose system coupling, the washer forms a curved fitting in the male hose's bib. An annular groove at the bottom flat side of the washer running around substantially the midsection of the washer wall, visible when the washer is laid on its opening, assists in generating a tight seal.

The above are the more important features of the invention that have been outlined in order that the more detailed description that follows may be better understood and in order that the present contribution to the art may better be appreciated. Additional features of the invention will be described hereinafter and will form the subject matter of the claims that follow.

It is to be understood, however, that the invention is not limited in its application to the details of construction set forth in the following description or illustrated in the drawings. Also it is to be understood that the phraseology and terminology employed herein are for the purpose of description and should not be regarded as limiting. The conception, upon which this disclosure is based, may readily be utilized in designing other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a side view of the washer positioned on its base edge.

FIG. 2 is a side view of the washer positioned on its opening.

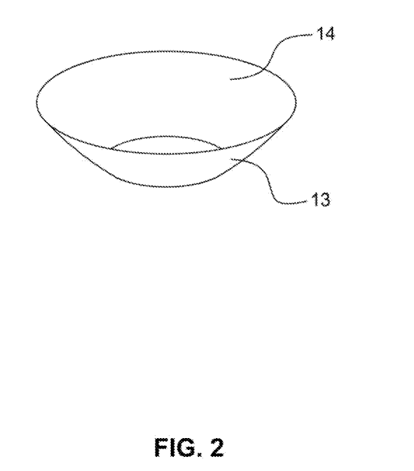

FIG. 3 is a top view of the washer positioned on its opening with an annular groove alongside washer perimeter.

### DESCRIPTION OF THE PREFERRED EMBODIMENT

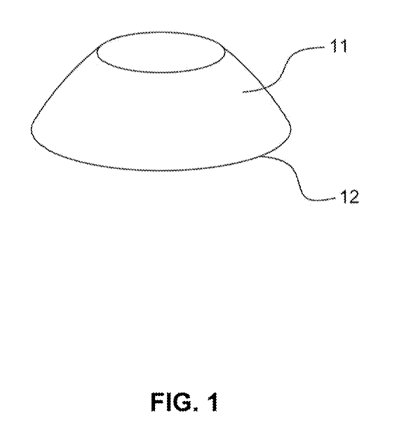

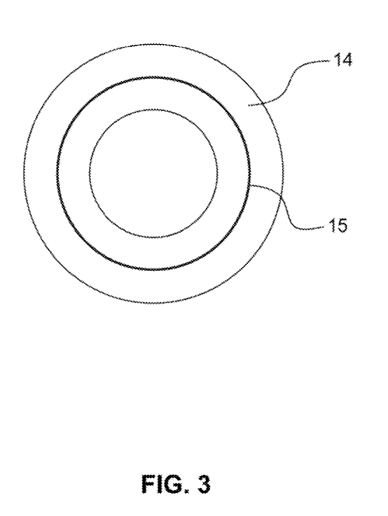

Referring to FIG. 1 there is disclosed a leak preventing washer with a wall 11 that substantially follows the shape of a right cone based frustum and slopes at an acute angle from its base 12. The washer of the present invention has a substantially even outer side of the wall 13 and an inner side of the wall 14, wherein the latter presents with an annular groove 15 running substantially through the wall midsection as shown in FIG. 3. When applied in the hose system, the washer forms a curved fitting in the male hoses bib and the groove 15 serves to provide a tighter seal.

Another embodiment of the present invention is a leak preventing washer that is substantially circular with a central opening. The washer has a convex outer side of the wall, a convex inner side of the wall and a central opening. The inner side of the wall presents with an annular groove running substantially through the wall midsection. When disposed in the hose system, the washer forms a curved fitting in the male hoses bib and the groove serves to provide a tighter seal.

The washer of either embodiment can be made of polyurethane or substantially equivalent material utilizing injection molding or other techniques known in the art.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings and are within the scope of the invention as determined by the appended claims when interpreted in accordance with the breadth to which they are entitled.

What is claimed is:

1. A leak preventing hose washer comprising:
A substantially inclined right-cone-based frustum wall,
said wall having outer and inner side,
said inner side having an annular grove running alongside perimeter of said wall.

2. A leak preventing hose washer of claim 1 wherein said washer is made of polyurethane.

3. A leak preventing hose washer comprising:
A substantially circular wall with a central opening,
said wall having an outer convex side and an inner concave side,
said inner side having a grove running alongside perimeter of said wall.

4. A leak preventing hose washer of claim 2 wherein said washer is made of polyurethane.
